(19) United States
(12) Patent Application Publication
(10) Pub. No.: US 2015/0348097 A1
(43) Pub. Date: Dec. 3, 2015

(54) AUTOCREATED CAMPAIGNS FOR HASHTAG KEYWORDS

(71) Applicant: Google Inc., Mountain View, CA (US)

(72) Inventors: Sofia Andrianakou, Mountain View, CA (US); Yuanying Xie, Mountain View, CA (US)

(21) Appl. No.: 14/356,227

(22) PCT Filed: Jan. 24, 2014
(86) PCT No.: PCT/GR2014/000007

§ 371 Date: May 5, 2014

(51) Int. Cl. G06Q 30/02; G06Q 50/00; G06F 17/30

(52) U.S. Cl. CPC G06Q 30/0251; G06F 17/30312; G06F 17/30876; G06Q 50/01

(57) ABSTRACT

Methods, systems and apparatus include computer programs encoded on a computer-readable storage medium for generating a creative. A method includes receiving input from a content sponsor including one, or more of a keyword, a topic, a vertical, or a subject identifying one or more hashtags associated with the input; generating a creative for an advertising campaign based at least in part, on the identified one or more hashtags, wherein generating includes using at least one hashtag as content in the creative; providing the creative to the content sponsor for approval; and receiving an indication of approval and using the creative in a campaign associated with the content sponsor.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for generating a creative. A method includes: receiving input from a content sponsor including one or more of a keyword, a topic, a vertical, or a subject; identifying one or more hashtags associated with the input; generating a creative for an advertising campaign based at least in part on the identified one or more hashtags, wherein generating includes using at least one hashtag as content in the creative; providing the creative to the content sponsor for approval; and receiving an indication of approval and using the creative in a campaign associated with the content sponsor.

In general, another aspect of the subject matter described in this specification can be implemented in computer program products. A computer program product is tangibly embodied in a computer-readable storage device and comprises instructions. The instructions, when executed by a processor, cause the processor to: receive input from a content sponsor including one or more of a keyword, a topic, a vertical, or a subject; identify one or more hashtags associated with the input; generate a creative for an advertising campaign based at least in part on the identified one or more hashtags, wherein generating includes using at least one hashtag as content in the creative; provide the creative to the content sponsor for approval; and receive an indication of approval and using the creative in a campaign associated with the content sponsor.

In general, another aspect of the subject matter described in this specification can be implemented in systems. A system includes one or more processors and one or more memory elements including instructions. The instructions, when executed, cause the one or more processors to: receive input from a content sponsor including one or more of a keyword, a topic, a vertical, or a subject; identify one or more hashtags associated with the input; generate a creative for an advertising campaign based at least in part on the identified one or more hashtags, wherein generating includes using at least one hashtag as content in the creative; provide the creative to the content sponsor for approval; and receive an indication of approval and using the creative in a campaign associated with the content sponsor.

These and other implementations can each optionally include one or more of the following features. Posts by users in a social network can be evaluated to extract hashtags. A hashtag can be identified in a post. Additional content that is related to or in proximity to the identified hashtag can be identified. The hashtag and the additional content can be stored in a data structure. Generating the creative can include identifying the one hashtag and additional information related to the one hashtag. A creative can be generated that includes the one hashtag and the additional information associated with the one hashtag. The additional information can be a media item. The media item can be an image. Generating the creative can include receiving additional content from the content sponsor for inclusion along with the at least one hashtag. A list of trending hashtags can be provided based at least in part on the received input. A selection of one hashtag from the list can be received. Generating a creative can include including the selection in the creative. Identifying one or more hashtags associated with the input can include compiling information on prevalence and recency of hashtags in content delivered through a social network. The one or more hashtags can be identified based on the compiled information. The one or more hashtags identified can be the highest rated hashtags.

Particular implementations may realize none, one or more of the following advantages. A campaign and/or a creative that is based on one or more hashtags and/or on content associated with one or more hashtags can be automatically generated for a content sponsor. A creative that includes a trending hashtag can be automatically generated. An automatically generated creative that includes a hashtag can be viewed by social media users who follow or who are otherwise associated with the hashtag or users that have posted content including the hashtag. Presenting a creative that includes a hashtag to users who have used the hashtag can result in a higher conversion rate and a higher return on investment as compared to presentation of the creative to users without an associated hashtag. Presenting a creative that includes a hashtag next to content that is associated with the hashtag can result in a higher conversion rate and a higher return on investment as compared to presentation of the creative next to content that is not associated with the hashtag.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for presenting content.

FIG. 2 is a block diagram of an example system for generating a creative.

FIG. 3 is a flowchart of an example process for generating a creative.

FIG. 4 is a flowchart of an example process for extracting hashtags.

FIG. 5 is a block diagram of computing devices that may be used to implement the systems and methods described in this document, as either a client or as a server or plurality of servers.

Like reference numbers and designations in the various drawings indicate like elements.

### DETAILED DESCRIPTION

A hashtag, as used herein, refers to a word or phrase that is prefixed with a non-alphabetic symbol (such as the # symbol). A hashtag can be used to index content, such as content that includes the hashtag. For example, a hashtag can be used in content that is distributed in social networking sites. Hashtags provide a ready means for grouping content, so as to enable ease of location of content that includes the tagged material.

Input including one or more of a keyword, a topic, a vertical, or a subject can be received from a content sponsor, such as using a campaign management user interface. One or more hashtags associated with the input can be identified, such as from a repository of hashtagged-based content. A creative for a campaign (e.g., advertising campaign) can be generated based at least in part on the identified one or more hashtags. One or more of the identified hashtags can be used as content in the generated creative. The creative can be provided to the content sponsor for approval. An indication of approval can be received and the creative can be used in the campaign.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server. For situations in which user-generated content (e.g., content associated with a hashtag) is used, such use may only be performed with content to which the user has given consent of such use.

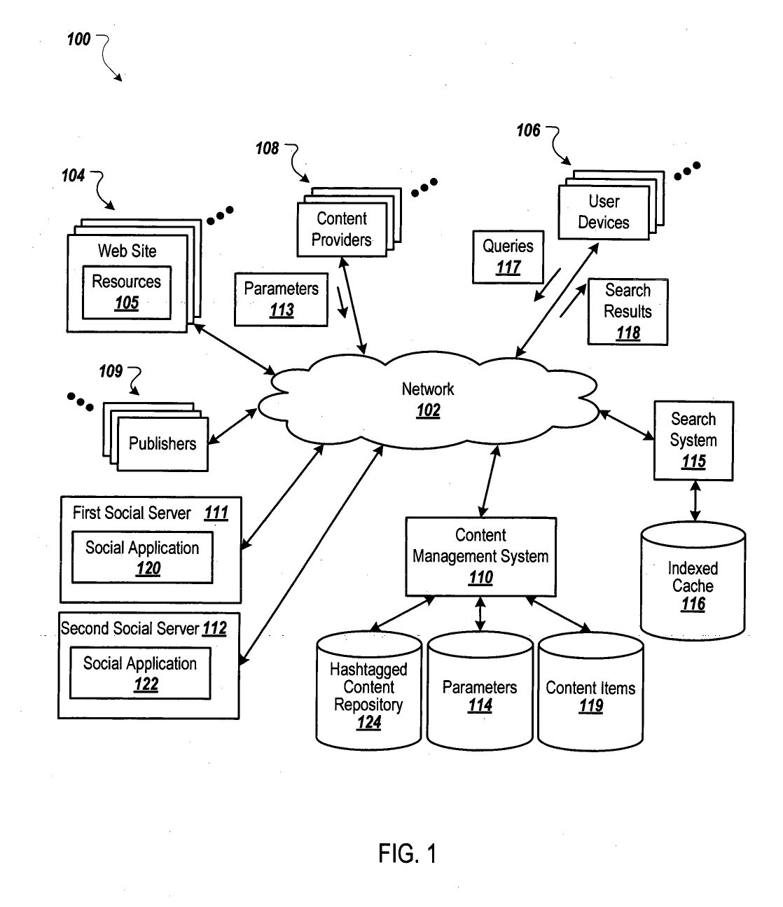

FIG. 1 is a block diagram of an example environment 100 for providing content to a user. The example environment 100 includes a network 102, such as a local area network (LAN), a wide area network (WAN), the Internet, or a combination thereof. The network 102 connects websites 104, user devices 106, content providers 108, publishers 109, a content management system 110, a first social server system 111, and a second social server system 112. The example environment 100 may include many thousands of websites 104, user devices 106, content providers 108, and publishers 109. The content management system 110 may be used for selecting and providing content in response to requests for content. The content providers 108 can be, for example, advertisers. Other types of content providers are possible.

A user device 106 is an electronic device that is under control of a user and is capable of requesting and receiving resources 105 over the network 102. Example user devices 106 include personal computers, tablet computers, mobile communication devices (e.g., smartphones), televisions, set top boxes, personal digital assistants and other devices that can send and receive data over the network 102. A user device 106 typically includes one or more user applications, such as a web browser, to facilitate the sending and receiving of data over the network 102. The web browser can interact with various types of web applications, such as a game, a map application, or an e-mail application, to name a few examples.

The first social server system 111 and the second social server system 112 allow users to interact with other users within a social framework. The first social server system 111 and the second social server system 112 each provide a social presence for users in the environment 100. For example, the first social server system 111 and the second social server system 112 can provide a social application 120 and a social application 122, respectively, to a user device 106. The social application 120 and the social application 122 can allow a user of a user device 106 to share information in a social network. For example, the social application 120 and the social application 122 can each be a social networking website that users can use to identify friends and social groups (e.g., circles), send and receive email, post messages and multi-media (e.g. photos, video, audio), track social events, provide updates and soon.

A user of a user device 106 can use the social application 120 or the social application 122 to post an update for the user in a social context. The first social server system 111 or the second social server 112 can, in response to the update, provide the update to one or more subscribers that the user has authorized to receive the update. For example, subscribers may be subscribed to an activity stream associated with the user, and may be enabled to view the update in the user's activity stream. An activity stream can show recent updates posted by the user 112.

The update can be, for example, a comment by the user on content exposed to the user by the social application 120 or the social application 122, such as a content item posted to their activity stream or to another user's activity stream, or some other content. As another example, the update can be a comment posted by the user on a blog. As yet another example, the update can be a designation that the user likes or dislikes certain content. The user can, for example, designate that they like or dislike a content item posted to their activity stream or to another user's activity stream, or some other content. An update can also be some other type of interaction with a content item in a user's activity stream, such as a designation to share or re-publish the content item. An update can include a hashtag.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a publisher 109, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as scripts).

A user device 106 can request resources 105 from a website 104. In turn, data representing the resource 105 can be provided to the user device 106 for presentation by the user device 106. User devices 106 can also submit search queries 117 to the search system 115 over the network 102. In response to a search query 117, the search system 115 can, for example, access the indexed cache 116 to identify resources 105 that are relevant to the search query 117. The search system 115 identifies the resources 105 in the form of search results 118 and returns the search results 118 to the user devices 106 in search results pages. A search result 118 is data generated by the search system 115 that identifies a resource 105 that is responsive to a particular search query 117, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot. In some implementations, the publisher 109 of a resource 105 can specify (e.g., using a publisher account management interface associated with the content management system 110) one or more hashtags to use as selection criteria for determining which content can be shown in a slot on a resource 105 associated with the publisher 109.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords and/or hashtags associated with a requested resource 105 or a search query 117 for which search results 118 are requested can also be provided to the content management system 110 to facilitate identification of content that is relevant to the resource 105 or search query 117. An identifier (e.g., cookie) associated with the user device 106 can be received with the request for content.

Based, for example, on data included in the request for content, the content management system 110 can select (e.g., from a content items data store 119) content items that are eligible to be provided in response to the request. One or more selected content items can be provided to the user device 106 in association with providing an associated resource 105 or search results 118. The provided content item(s) can be presented on the user device 106, in one or more respective slots.

The content management system 110 can, for example, select a content item having characteristics matching the characteristics of a given slot. As another example, content items having selection criteria (e.g., keywords, hashtags) that match resource keywords or hashtags, in the search query 117, or keywords or hashtags included in the search results 118 may be selected as eligible content items by the content management system 110. As yet another example, the content management system 110 can identify a content item in the content items datastore 119 that is associated with a hashtag or keyword that matches a hashtag or keyword included in a user profile associated with the requesting user device 106. The identified content item can be selected by the content management system 110 and provided to the requesting user device 106.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). A quality score can be determined, for example, based on a quality of match between, for example, a keyword or hashtag associated with a content item and keywords or hashtags associated with a resource that includes the slot associated with the request. As another example, a quality score can be determined based on a quality of match between a keyword or hashtag associated with a content item and keywords or hashtags included in a user device profile associated with the requesting user device.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 113 which define a content campaign. The content campaign can be created and activated for the content provider 108 according to the parameters 113 specified by the content provider 108. The campaign parameters 113 can be stored in a campaign database 114. Campaign parameters 113 can include, for example, a campaign name, a preferred content network for placing content, a budget for the campaign, start and end dates for the campaign, a schedule for content placements, content (e.g., creatives), bids, and selection criteria. Selection criteria can include, for example, a language, one or more geographical locations or websites, and/or one or more selection terms. The selection terms can be used in evaluating when to serve content items in response to received requests for content. The selection terms, can include, for example, one or more keywords and/or hashtags.

Various factors may pose challenges for campaign and creative creation for a content provider 108. For example, content providers 108 can vary in their sophistication and ability with regards to generation of creatives. For instance, some content providers 108 may not have much experience with creation of content for creatives and/or with identifying selection criteria for use in a campaign. As another example, landing page content and other content associated with some content providers 108 may change frequently. The content provider 108 may desire to run campaigns based on their changing content, but may not have the resources or the desire to repeatedly create and/or edit campaigns.

A content provider 108 may desire to run campaigns that are based off of popular hashtags, a content provider brand-oriented hashtag, and/or user-generated content that is associated with a hashtag. The content provider 108 may wish to promote their campaign to users who are creating content associated with a particular hashtag. A content provider 108 may not know which hashtags are the most popular or what content has been associated with hashtags.

To aid a content provider 108 in campaign and creative creation, the content management system 110 can provide tools that allow for automatic generation of creatives and campaigns that are associated with hashtags. For example, the content management system 110 can provide a user interface which allows the content sponsor 108 to provide an input, such as a keyword, topic, vertical or subject which describes a campaign that the content provider 108 would like to create. The content management system 110 can identify one or more hashtags from a hashtagged content repository 124 that match the input. In some implementations, hashtags that match the input and that have an associated popularity that is more than a threshold are identified and presented to the content provider for consideration for inclusion in a campaign.

The hashtagged content repository 124 can include content (e.g., text content, image content, video content) that has been gathered (e.g., by the content management system 110) from plural, different content sources that are associated with hashtags. The content management system 110 can, for example, gather content from one or both of the first social server system 111 and the second social server system 112, store the gathered content in the hashtagged content repository 124, and, in some implementations, index the stored content by hashtags.

When gathering user-generated content, the content management system 110 can gather only user-generated content to which users have explicitly granted access. For example, a content provider 108 may run a brand promotion and may encourage users to post or submit content related to the brand promotion. For example, a shoe company can run a campaign centered around a #born2run hashtag and may encourage users to post running photos and other content and tag such content with the #born2run hashtag. User posts and submissions can be, for example, used as entry into a sweepstakes or other contest. The users can agree to use of content associated with a particular hashtag as part of submitting a post associated with the hashtag

The content management system 110 can retrieve content (e.g., images, videos, textual content) in the hashtagged content repository 124 that is associated with one or more identified hashtags. The content management system 110 can identify content to be used in a creative from one or more landing pages associated with the content provider 108. The content management system 110 can automatically generate one or more creatives that include one or more of the one or more identified hashtags, the retrieved hashtag-associated content, and/or the identified landing page content. The creative(s) can be provided to the content provider 108 for approval, an indication of approval can be received, and the creative(s) can be used in a campaign. The creatives can be used in an existing campaign and/or in a newly created campaign. In some implementations, the content management system 110 can configure a campaign so that the identified hashtags are used as selection criteria for the campaign.

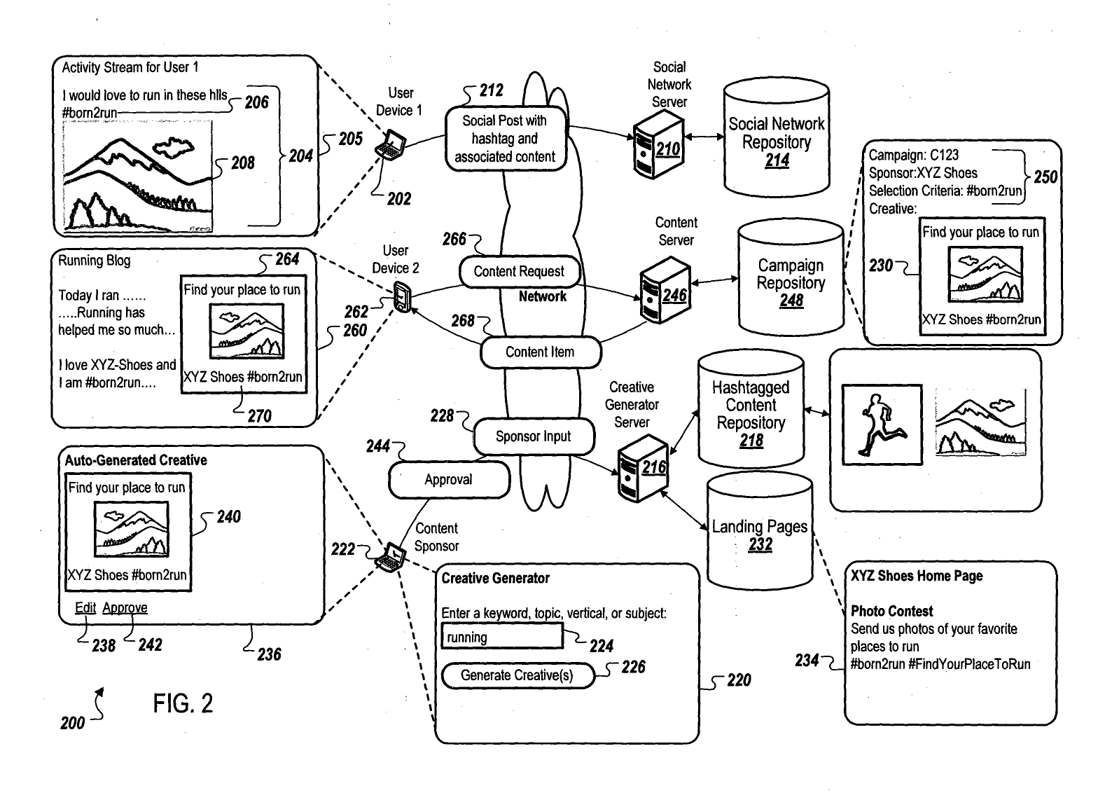

FIG. 2 illustrates an example system 200 for providing content. A user of a first user device 202 posts a message 204 to an activity stream associated with a social network and with the user of the first user device 202. The message 204 is presented on a web page 205 and includes a hashtag 206 and an image 208. The message 204 can be sent to a social network server 210 (e.g., as a social post 212). The message 204, including the hashtag 206 and the image 208, can be stored in a repository 214 and distributed to users of the social network that are associated with the user of the user device 202. The hashtag 206 may be associated, for example, with an XYZ Shoes shoe manufacturer (e.g., the hashtag 206 may be promoted by the XYZ Shoes manufacturer in content campaigns and one or more of the content campaigns may encourage customers of XYZ Shoes to create and promote content and tag such content using the hashtag 206). In some implementations, the hashtag 206 can be used as an index for the social post 212 that is stored in the repository 214. For example, the repository 214 may be indexed and searchable by hashtags. The repository 214 can include metadata for each stored content item, such as a number of affinity designations (e.g., “likes”), or number of publications or re-publications of the content item. Other forms of metadata are possible.

A creative generator server 216 (or another server or system) can gather content from the social network (e.g., from the repository 214 and/or the social network server 210), and/or from other content sources (e.g., other social networks) that include or present content that is associated with hashtags. For example, the creative generator server 216 can identify the hashtag in 206 in the social post 212 and can identify the image 208 as additional content that is related to or in proximity to the hashtag 206. In some implementations, the creative generator server 216 can store the gathered content in a hashtagged content repository 218 and index the stored content by particular hashtags. For example, the image 208 can be stored in the hashtagged content repository 218 in association with the #born2run hashtag 206. For situations in which user-generated content (e.g., content associated with a hashtag) is stored, such use may only be performed with content to which the user has given consent of such use.

A creative generator user interface 220 can be presented on a content sponsor user device 222. The content sponsor can provide an input of a keyword, topic, vertical, or subject using an input control 224. For example, the content sponsor has provided an input of “running” using the input control 224. The content sponsor can select a control 226 to request automatic generation of one or more creatives based on one or more hashtags that have been identified based on the input specified using the input control 224.

For example, after selection of the control 226, the input entered using the input control 224 can be provided to the creative generator server 216, as illustrated by a sponsor input 228. The creative generator server 216 can identify one or more hashtags that are associated with the sponsor input 228. For example, the creative generator server 216 can identify one or more hashtags in the hashtagged content repository 218 that match (e.g., partial match, exact match, synonym or other conceptual match) the sponsor input 228. As another example, the creative generator server 216 can identify hashtags based on a match and on prevalence and recency of hashtags in the hashtagged content repository 218. For instance, the creative generator server 216 can identify highest-rated hashtags in terms of prevalence and relevancy that match the sponsor input 228. For example, the creative generator server 216 can identify the #born2run hashtag as a hashtag that matches the sponsor input 228 and has at least a minimum prevalence and recency.

The creative generator server 216 can identify hashtags based on compiled prevalence and recency information. In some implementations, the prevalence and recency information is compiled before the sponsor input 228 is received (e.g., the creative generator server 216 or another server or system can periodically (e.g., daily) compile the prevalence and recency information). In some implementations, the creative generator server 216 compiles prevalence and recency information in real time in response to receiving the sponsor input 228.

The creative generator server 216 can generate one or more creatives based on the identified hashtags. For example, the creative generator server 216 can generate a creative 230. A creative can, but is not required to include one or more of the identified hashtags as content in the creative. For example, the hashtag #born2run 206 is included in the creative 230.

The creative generator server 216 can determine content for the creative 230 from multiple sources. For example, content in the hashtagged content repository 218 that is associated with one or more identified hashtags can be used as content in a creative. For example, the creative 230 includes a copy of the image 208.

As another example, the creative generator server 216 can generate the creative 230 based at least in part on content included in one or more landing pages associated with the content sponsor. For example, the creative generator server 216 can identify a landing page (e.g., an address of a landing page) associated with the content sponsor in a landing pages repository 232. For instance, a landing page 234 can be identified. The creative generator server 216 can identify content in the landing page 234 as content to use in the creative 230. For example, the phrase “Find your place to run” can be determined based on an identified hashtag #FindYourPlaceToRun included in the landing page 234. Landing page content identified for use in a creative can be a hashtag, content associated with (e.g., in proximity to) a hashtag, or other content (e.g., text, images, other types of content) included in the landing page. In addition to landing pages being identified in the landing pages repository 232, the content sponsor can provide a landing page address (e.g., using the creative generator user interface 220).

In some implementations, the creative generator server 216 can receive additional content from the content sponsor for inclusion in a generated creative. For example, as shown in an approval user interface 236, the content sponsor can select an edit control 238 to edit an auto-generated creative. In some implementations, the content sponsor provides content (e.g., using the creative generator user interface 220 or another interface) when requesting generation of a creative.

A landing page associated with the content sponsor can be associated with the creative 230 such that the landing page is presented when the creative 230 is presented to a user and the user selects the creative 230. For example, the creative generator server 216 can associate the landing page 234 with the creative 230. As another example, the content sponsor can provide input that indicates a landing page to which the creative 230 is to be associated. A generated creative can be (but is not required to be) associated with a landing page from which content was used in generating the creative. For instance, the creative 230 can be associated with a landing page other than the landing page 234.

The content sponsor can approve a generated creative for use in a campaign associated with the content sponsor. For example, the content sponsor can view a copy 240 of the generated creative 230 in the approval user interface 236. The content sponsor can select an approve control 242 to approve the generated creative 230. As mentioned, the content sponsor can edit a generated creative before approval. In response to selection of the approve control 242, an approval indication input 244 can be sent to the creative generator server 216.

The creative generator server 216 or a content server 246 can associate the creative 230 with a campaign associated with the content sponsor. For example, the creative 230 can be stored in a campaign repository 248 in association with campaign parameters 250, such as a campaign identifier, a content sponsor identifier, selection criteria, bid information, and other campaign parameters. The creative generator server 216 can, for example, configure the campaign so that one or more of the identified hashtags are used as selection criteria for the campaign.

After the creative 230 is associated with a campaign, the content server 246 can serve the creative 230 in response to received requests for content. For example, a web page 260 presented on a user device 262 includes a content slot 264. The web page 260 can be configured to send a content request 266 for the content slot 264 to the content server 246. The content server 246 can select the creative 230 in response to the content request 266 and provide the creative 230 to the user device 262 (e.g., as illustrated by a provided content item 268) for presentation in the content slot 264 (e.g., as illustrated by a displayed creative 270).

Although the above description sets forth an example of creative generation occurring in response to user input, creatives can be automatically generated based on other conditions. For example, the creative generator server 216 can periodically identify hashtags, hashtagged content, and/or content in landing pages associated with the content sponsor and automatically generate creatives when new hashtags and/or new landing page content is identified. As another example, the creative generator server 216 can be notified or can determine that landing page content has changed and in response to such an event can automatically identify hashtags, hashtagged content, and/or new landing page content, and generate creatives based on such identified information.

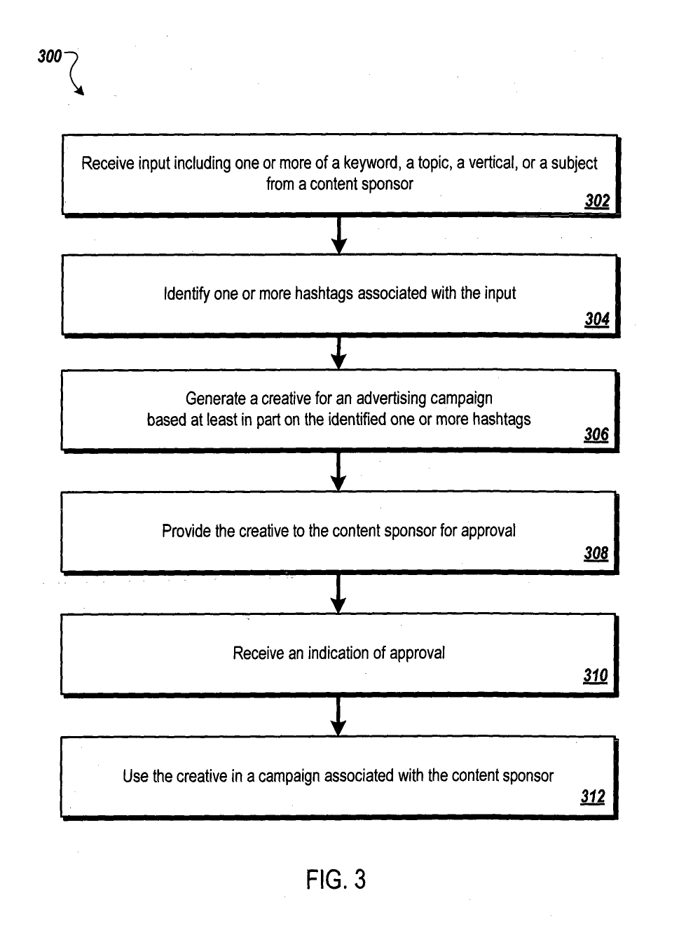

FIG. 3 is a flowchart of an example process 300 for generating a creative. The process 300 can be performed, for example, by the content management system 110 described above with respect to FIG. 1.

Input from a content sponsor including one or more of a keyword, a topic, a vertical, or a subject is received (302). Based on the input, one or more hashtags can be identified (304). The input can be received, for example, using a campaign management user interface. The one or more identified hashtags can be hashtags that are related to the keyword, topic, vertical, subject, or another identified hashtag. The one or more hashtags can be identified, for example, in a repository. The repository can include, for example, compiled information on prevalence (e.g., how many posts include the hashtag) and recency of hashtags in content delivered through a social network. The one or more identified hashtags can be the highest rated hashtags that match the keyword, topic, vertical, or subject.

A creative is generated for an advertising campaign based at least in part on the identified one or more hashtags (306): The creative can be generated for content campaigns other than advertising campaigns. Generating the creative can include using at least one hashtag as content in the creative. In some implementations, additional content is received from the content sponsor or otherwise identified for inclusion along with the one or more hashtags. In some implementations, the creative is generated based on content included in a landing page associated with the content sponsor. For example, the landing page can be evaluated and prominent content in the landing page can be identified and used when generating the creative.

The creative is provided to the content sponsor for approval (308). For example, the creative can be presented to the content sponsor in an approval user interface, wherein the approval user interface includes an approval user interface control for approving the generated creative, a rejection user interface control for rejecting the generated creative, and one or more editing user interface controls for editing the generated creative.

An indication of approval is received (310). For example, user input selecting the approval user interface control can be received. The user input selecting the approval user interface control can be received after the user has edited the generated creative.

The creative is used in a campaign associated with the content sponsor (312). For example, the creative can be selected by a content management system in response to a request for content received by a user device. The creative can be provided to and presented on the user device, such as in a content slot.

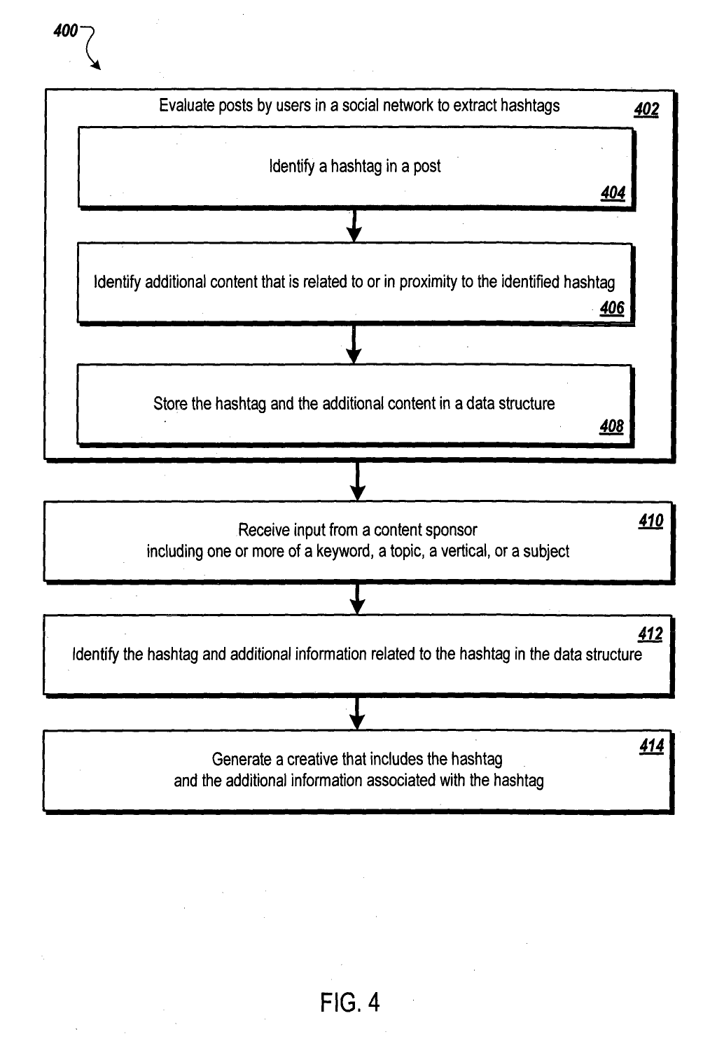

FIG. 4 is a flowchart of an example process 400 for extracting hashtags. The process 400 can be performed, for example, by the content management system 110 described above with respect to FIG. 1. For situations in which user-generated content (e.g., content associated with a hashtag) is stored or used, such use may only be performed with content to which the user has given consent of such use.

Posts by users in one or more social networks are evaluated to extract hashtags (402). For example, as part of the evaluation, a hashtag is identified in a post (404). The post can, for example, be a post on a blog, a post on a wiki, a post by a first user on an activity stream associated with the first user, a post by the first user on an activity stream associated with a second user that is associated with the first user in the social network, a post by the first user on an activity stream that is associated with an entity (e.g., an entity that the first user has chosen to follow or be otherwise associated with), or some other type of social post.

As part of the evaluation, additional content that is related to or in proximity to the identified hashtag is identified (406). The additional content can include, for example, text content, including one or more other hashtags and/or non-hashtag text, media items (e.g., image, audio, video), or other content.

The hashtag and the additional content are stored in a data structure (408). In some implementations, metadata related to the hashtag is stored in the data structure in association with the hashtag. Metadata can include, for example, extraction date and time information, a count of extractions associated with a particular hashtag, and other metadata. The hashtag and the additional content can be indexed by the hashtag. Indexing by the hashtag can allow the hashtag and the additional content to be retrieved when the hashtag is provided as a search query.

For example, input including one or more of a keyword, a topic, a vertical, or a subject is received from a content sponsor (410). The input can be received, for example, using a campaign management user interface.

The hashtag and additional information related to the hashtag are identified in the data structure (412). For example, a search can be performed on the data structure using the hashtag as a search query. An entry in the data structure that has the hashtag as an index can be identified. The additional information related to the hashtag can include, for example, text information, one or more media content items, or metadata associated with the hashtag.

A creative is generated that includes the hashtag and the additional information associated with the hashtag (414). For example, a creative can be generated that includes the hashtag and an image that was stored in association with the hashtag. The creative can be used in a campaign associated with the content sponsor. For example, the creative can be selected by a content management system in response to a request for content received by a user device. The creative can be provided to and presented on the user device, such as in a content slot.

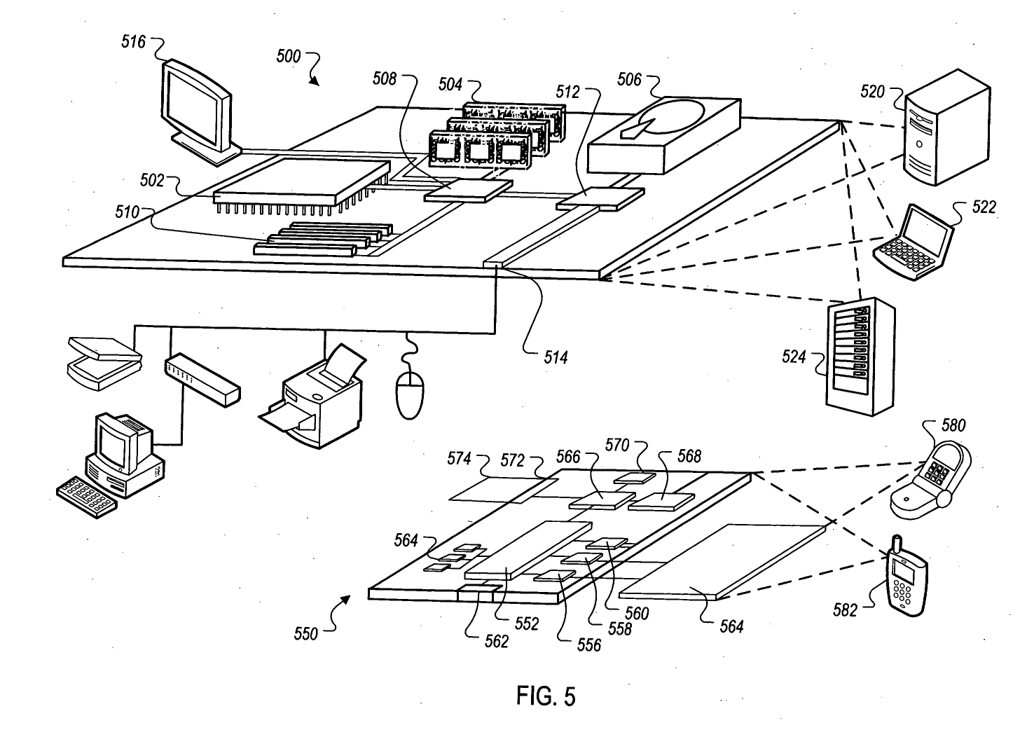

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. The computer-readable medium is not a propagating signal. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is illustrative only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth® or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth®, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
receiving input from a content sponsor including one or more of a keyword, a topic, a vertical, or a subject;
identifying one or more hashtags associated with the input;
generating a creative for an advertising campaign based at least in part on the identified one or more hashtags, wherein generating includes using at least one hashtag as content in the creative;
providing the creative to the content sponsor for approval; and
receiving an indication of approval and using the creative in a campaign associated with the content sponsor.

2. The method of claim 1 further comprising evaluating posts by users in a social network to extract hashtags including:
identifying a hashtag in a post;
identifying additional content that is related to or in proximity to the identified hashtag;
storing the hashtag and the additional content in a data structure;
wherein generating the creative further includes identifying the one hashtag and additional information related to the one hashtag and wherein the method further includes generating a creative that includes the one hashtag and the additional information associated with the one hashtag.

3. The method of claim 2 wherein the additional information is a media item.

4. The method of claim 3 wherein the media item is an image.

5. The method of claim 1 wherein generating the creative further comprises receiving additional content from the content sponsor for inclusion along with the at least one hashtag.

6. The method of claim 1 further comprising providing a list of trending hashtags based at least in part on the received input, receiving a selection of one hashtag from the list, and wherein generating a creative further includes including the selection in the creative.

7. The method of claim 1 wherein identifying one or more hashtags associated with the input further comprises compiling information on prevalence and recency of hashtags in content delivered through a social network and identifying the one or more hashtags based on the compiled, information.

8. The method of claim 7 wherein the one or more hashtags identified are the highest rated hashtags.

9. A system comprising:
one or more processors; and
one or more memory elements including instructions that when executed cause the one or more processors to:
receive input from a content sponsor including one or more of a keyword, a topic, a vertical, or a subject;
identify one or more hashtags associated with the input;
generate a creative for an advertising campaign based at least in part on the identified one or more hashtags, wherein generating includes using at least one hashtag as content in the creative;
provide the creative to the content sponsor for approval; and
receive an indication of approval and using the creative in a campaign associated with the content sponsor.

10. The system of claim 9 wherein the additional information is a media item.

11. The system of claim 9 wherein the media item is an image.

12. The system of claim 9 wherein generating the creative further comprises receiving additional content from the content sponsor for inclusion along with the at least one hashtag.

13. The system of claim 9 wherein the one or more memory elements further include instructions that when executed cause the one or more processors to provide a list of trending hashtags based at least in part on the received input and receive a selection of one hashtag from the list, and wherein generating a creative further includes including the selection in the creative.

14. The system of claim 9 wherein identifying one or more hashtags associated with the input further comprises compiling information on prevalence and recency of hashtags in content delivered through a social network and identifying the one or more hashtags based on the compiled information.

15. A computer program product tangibly embodied in a computer-readable storage device and comprising instructions that, when executed by a processor, cause the processor to:
receive input from a content sponsor including one or more of a keyword, a topic, a vertical, or a subject;
identify one or more hashtags associated with the input;
generate a creative for an advertising campaign based at least in part on the identified one or more hashtags, wherein generating includes using at least one hashtag as content in the creative;
provide the creative to the content sponsor for approval; and
receive an indication of approval and using the creative in a campaign associated with the content sponsor.

16. The product of claim 15 wherein the additional information is a media item.

17. The product of claim 15 wherein the media item is an image.

18. The product of claim 15 wherein generating the creative further comprises receiving additional content from the content sponsor for inclusion along with the at least one hashtag.

19. The product of claim 15 wherein the instructions further include instructions that when executed cause the one or more processors to provide a list of trending hashtags based at least in part on the received input and receive a selection of one hashtag from the list, and wherein generating a creative further includes including the selection in the creative.

20. The product of claim 15 wherein identifying one or more hashtags associated with the input further comprises compiling information on prevalence and recency of hashtags in content delivered through a social network and identifying the one or more hashtags based on the compiled information.
